(19) United States
(12) Patent Application Publication
(10) Pub. No.: US 2017/0313162 A1
(43) Pub. Date: Nov. 2, 2017

(54) COLORABLE WINDOW SHADE

(71) Applicant: Johnny Lamar Brown, Chattanooga, TN (US)

(72) Inventor: Johnny Lamar Brown, Chattanooga, TN (US)

(73) Assignee: Remington Industries, Inc., Ooltewah, TN (US)

(21) Appl. No.: 15/493,938

(22) Filed: Apr. 21, 2017

Related U.S. Application Data
(60) Provisional application No. 62/330,109, filed on Apr. 30, 2016.

(51) Int. Cl. B60J 1/20

(52) U.S. Cl. CPC B60J 1/2091

(57) ABSTRACT

A colorable sunshade system for an automobile includes a thin panel having a periphery shaped to fit within one of an automobile's windows or windshield. The panel has an outer surface for disposition outwardly against an inside surface of glass of the window or windshield, and an inner surface visible to occupants of the automobile when the outer surface is so disposed. One of the inner or outer surfaces is comprised of a white background with an image printed thereon, the image comprising one or more dark outlines surrounding white interiors for being filled with color. The system may also include means for temporarily affixing the panels into the windows or windshield, and means for filling the white interiors with color.

### RELATED APPLICATION:

This application claims benefit to U.S. Provisional Application No. 62/330109 filed on 30-Apr.-2016. The teachings thereof are incorporated herein in their entirety by reference.

### FIELD OF THE INVENTION:

The present invention is related to sunshades for affixing to or positioning against the inside surface of vehicle windows to shade the interior of the vehicle or its occupants.

### BACKGROUND:

Sunshades for automobiles are well known. Such sunshades have a variety of shapes, features, and purposes, including being positioned inside and against an automobile's windshield or rear window when the vehicle is left parked in the hot sun to protect the interior of the car and so that the seats and other components will remain relatively cool to the touch when the driver returns, to hang from or mount to the interior of the side windows to keep direct sunlight off of occupants such as sleeping children or reading passengers, or to hide valuable contents inside the vehicle from burglars and such.

Numerous means are common for affixing or otherwise positioning sunshades in vehicles. Such means range from the simple to the complicated. The more simple means include taping the shades to the windows, coating an temporary adhesive backing on the shades, having a static-sticking rear surface on the shades, or using suction cups. Less simple means include hanging the shades from clips or such that hook over the top of side windows or having extendible and collapsible frames that temporarily secure the sunshades to the surrounding portion of the automobile. More elaborate means include retractable mechanisms and adjustable frames. Many examples of such means may be found in the prior art, including (but not limited to) U.S. Pat. Nos. 5,002,327, 5,042,550, 5,042,551, 5,044,686, 5,333,665, 5,937,929, 6,047,762, 6,135,191, 7,121,315, 7,131,683, 7,140,662, 7,748,433, 8,998,290, 9,162,553 and 9,186,961, the teachings of which are incorporated herein in their entireties by reference.

There exists a need for sunshades positioned inside and against one or more of an automobile's windows, such as when the vehicle is left parked in the hot sun, to protect the interior of the car and keep it relatively cool, and such is an object of the present invention. There exists a need for sunshades to hang from or mount to the interior of the vehicle's windows to keep direct sunlight off of its occupants, and such is an object of the present invention. There exists a need for sunshades to hide valuable contents inside vehicles from burglars, and such is an object of the present invention. There exists the need for entertaining and occupying children while travelling in a vehicle, and such is an object of the present invention. There exists the need for in-car children's activities, especially during long trips, and such is an object of the present invention. There exists the need to attract the attention of children away from the doldrums of automobile travel, and such is an object of the invention. Further needs and objects exist which are addressed by the present invention, as may become apparent by the included disclosure of an exemplary embodiment thereof.

### SUMMARY OF THE INVENTION

The invention may be embodied in or practiced using a sunshade having an outline for guiding a child to create a colorful image thereon. The outline may be a black-lined image having various white areas between lines into which the child will add color, by means such as (but not limited to) crayons, paint, permanent markers, or dry-erase markers.

The invention may be embodied in or practiced using a colorable sunshade system for an automobile having a thin panel with a periphery shaped to fit within one of an automobile's windows or windshield. The panel may have an outer surface for disposition outwardly against an inside surface of glass of the window or windshield, and an inner surface visible to occupants of the automobile when the outer surface is so disposed. One of the inner or outer surfaces may have a white background with an image printed thereon, the image including one or more dark outlines surrounding white interiors for being filled with color.

The system may include means for temporarily affixing the outer surface into the disposition. And the system may include one or more of crayons, markers, or paint for filling the white interiors with color. The white background is comprised of paper. Or the white background may be laminated with a transparent glossy layer. The white background is comprised of a dry-erasable surface and the means for filing the interiors with color may be dry-erase markers.

The means for temporarily affixing may be from the group including a sticky layer on at least a portion of the outer surface, one or more suction cups, and one of more hooks for hanging the panel from a top edge of the inside surface of glass. Or the means for temporarily affixing may include an extendible frame for securing the panel to a portion of the automobile surrounding the window or windshield.

Further features and aspects of the invention are disclosed with more specificity in the detailed description and drawings provided herein.

### BRIEF DESCRIPTION OF THE DRAWINGS:

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1A is a plan view of a windshield sunshade according to a first embodiment in its un-colored state;

FIG. 1B is a partial plan view of the windshield sunshade of FIG. 1A in its colored state;

FIG. 2A is a plan view of a windshield sunshade according to a second embodiment in its un-colored state;

FIG. 2B is a partial plan view of the windshield sunshade of FIG. 2A in its colored state;

FIG. 3A is a plan view of a windshield sunshade according to a third embodiment in its un-colored state;

FIG. 3B is a partial plan view of the windshield sunshade of FIG. 3A in its colored state;

FIG. 4A is a plan view of a side window sunshade according to a fourth embodiment in its un-colored state;

FIG. 4B is a plan view of the side window sunshade of FIG. 4A in its colored state;

FIG. 5A is a plan view of a side window sunshade according to a fifth embodiment in its un-colored state;

FIG. 5B is a plan view of the side window sunshade of FIG. 4A in its colored state;

FIG. 6 is a front view of an automobile having the windshield sunshade of FIG. 1B installed thereto; and

FIG. 7 is an inside view of an automobile rear side door having the side window sunshade of FIG. 4B installed thereto.

### DETAILED DESCRIPTION OF EXEMPLARY EMBODIMENTS:

The sunshades disclosed herein may be made of a paper-based material so that they can be colored with crayons, markers, or paint. Preferably, the are made of a laminated panel having a 2 mm thick foam layer bound to a kraft paper coloring side by a non-woven binder. In the case where the coloring surface faces the car's interior, the outside may be covered in a reflective foil layer, also bound by the non-woven binder. The preferred means for coloring the sunshades is the use of ink markers, such as “Magic Markers®”.

The sunshades may alternatively be made of or have laminated thereon a glossy plasticized coating or layer, or a typical “dry-erase” coating or layer, so that the coloring may be simply wiped off and the sunshade can be repeatedly re-colored. While not shown, the sunshades are preferably “accordion foldable” to reduce their size for storage between uses, and have a shape that, when expanded, fits snuggly into the intended windshield or window. Alternatively, they may be affixed to or positioned into the vehicle by any known or obvious means, such as (but not limited to) those taught by the prior art like (but not limited to) U.S. Pat. Nos. 5,002,327, 5,042,550, 5,042,551, 5,044,686, 5,333,665, 5,937,929, 6,047,762, 6,135,191, 7,121,315, 7,131,683, 7,140,662, 7,748,433, 8,998,290, 9,162,553 and 9,186,961, the teachings of which are incorporated herein in their entireties by reference. Numerous such means are common for affixing or otherwise positioning sunshades in vehicles. Such means range from the simple to the complicated. The more simple means include taping the shades to the windows, coating a temporary adhesive backing on the shades, or having a static-sticking rear surface on the shades. Less simple means include hanging the shades from clips or such that hook over the top of side windows. More elaborate means include retractable mechanisms and adjustable frames. Many examples of such means may be found in the prior art and may be useful in practicing the invention.

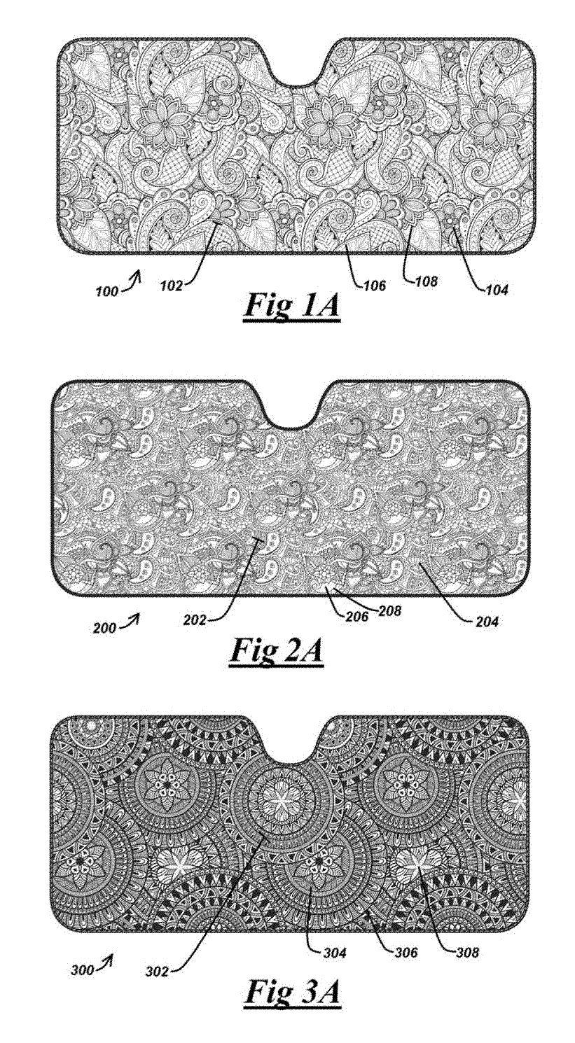

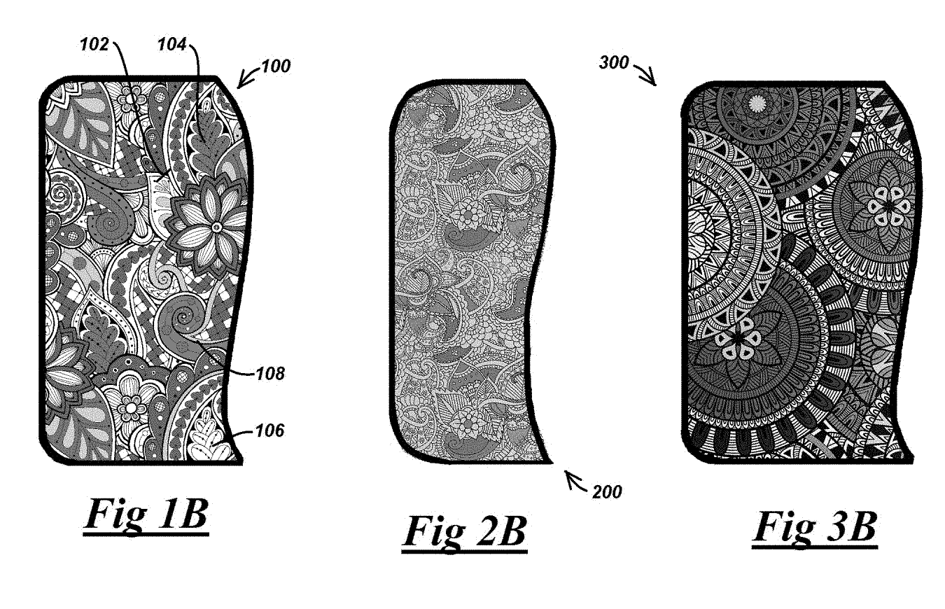

Referring first to FIG. 1A sunshade 100 is shown in its pre-colored state. The sunshade's outer surface 102 is intended to be disposed against the interior of an automobile's windshield. One of the sunshade's inner or outer surfaces (in this example the outer surface), has a white background with an artistic pattern 104 printed thereon. The pattern comprises black-lined shapes 106 that surround small areas of the white background 108. Referring to FIG. 1B, it is seen that these small areas have been filled with color and the sunshade has been placed behind the windshield 600 of a car. The coloring may have been done by crayons, paint, or markers. Or in the case where the surface is dry-erasable, may have been done with common dry-erase markers. The appropriate means for coloring the panels may be sold together with the sunshade or may be obtained independently.

Referring to FIGS. 2A and 2B show a second windshield sunshade 200, similar to that of FIGS. 1A and 1B, except including a different pattern.

FIGS. 3A and 3B show a second windshield sunshade 300, similar to that of FIGS. 1A and 1B, except including a different pattern.

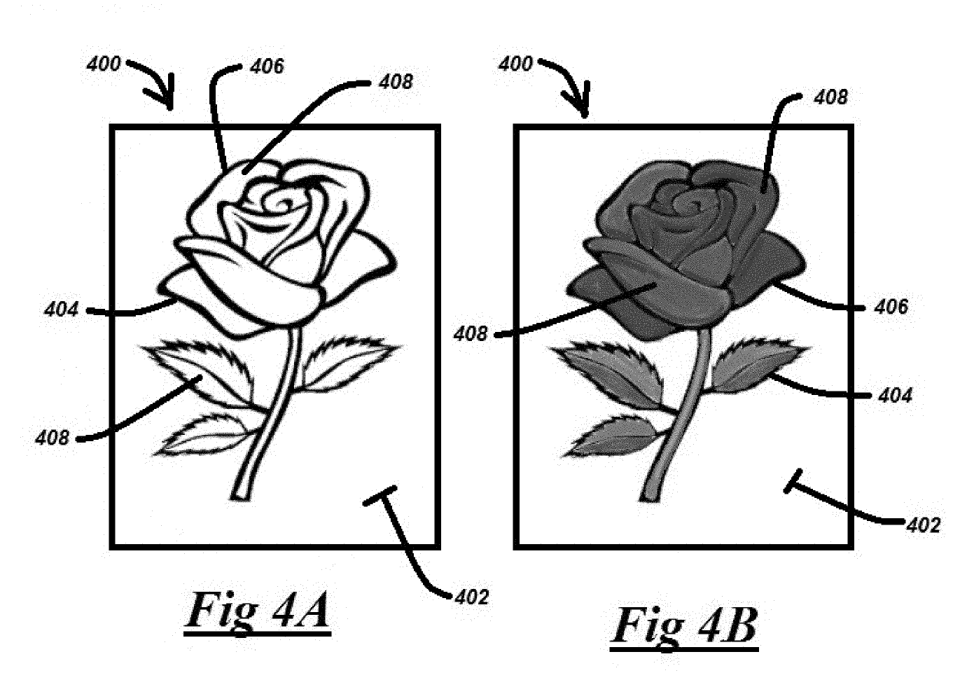

Referring next to FIGS. 4A side window sunshade 400 is shown in its pre-colored state. The sunshade's outer surface is intended to be disposed against the interior of one of an automobile's side windows. One of the sunshade's inner or outer surfaces (in this example the inner surface 402), has a white background with an artistic pattern 404 printed thereon. The pattern comprises black-lined shapes 406 that surround small areas of the white background 408. Referring to FIG. 4B, it is seen that these small areas have been filled with color and the sunshade has been affixed to the inside of the car's rear window 602. This may have been done by crayons, paint, or markers. Or in the case where the surface is dry-erasable, may have been done with common dry-erase markers. The appropriate means for coloring the panels may be sold together with the sunshade or may be obtained independently.

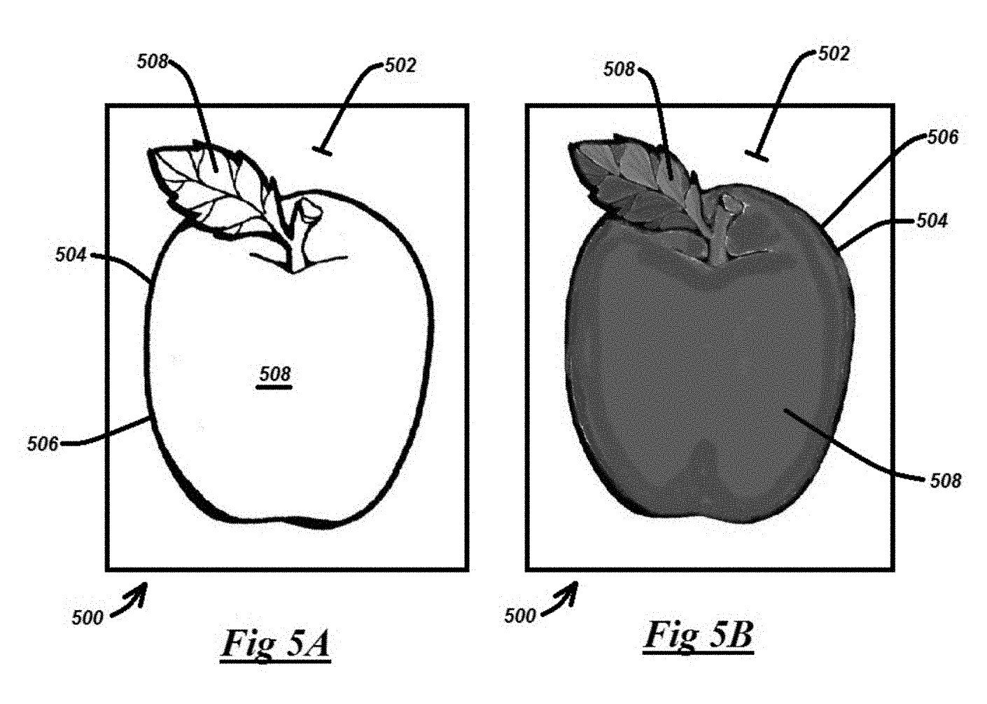

FIGS. 5A and 5B show a second side window sunshade 400, similar to that of FIGS. 4A and 4B, except including a different pattern.

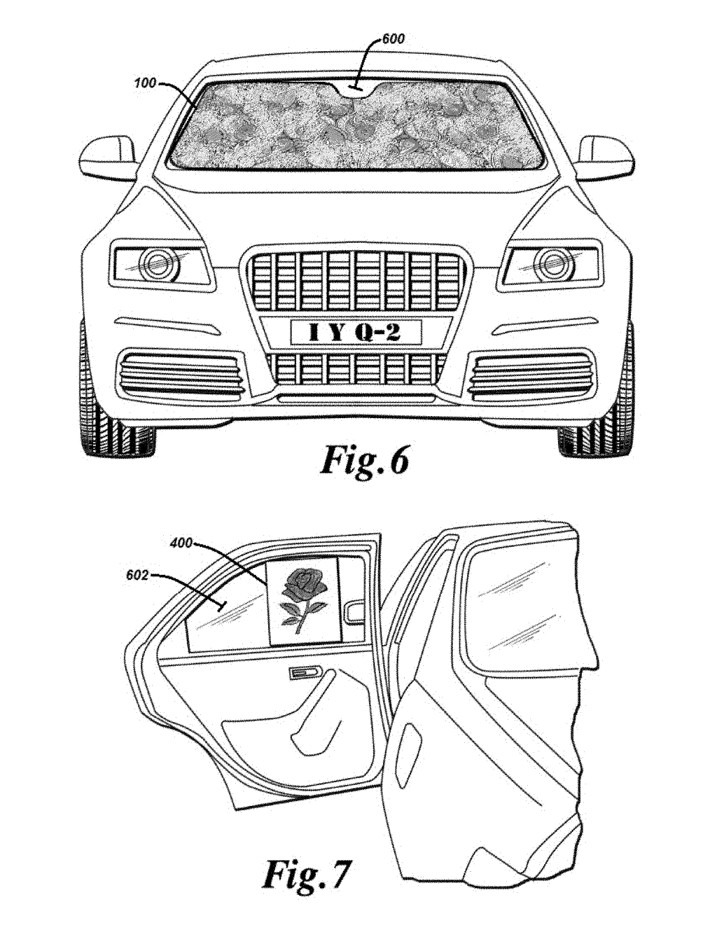

FIG. 6 shows the windshield sunshade 100 of FIG. 1B mounted against the inside of the windshield 600 of an automobile. FIG. 7 shows the side window sunshade of FIG. 4B mounted on the inside of a rear window 602 of the automobile.

In general, the windshield sunshades may be made of a large “accordion folded” panel that is unfolded and placed inside an automobile's front windshield such as whenever the car is parked in a sunny area. The windshield and side window sunshades would preferably be made of a white material, which may accept “magic marker” ink. They preferably have outlines on them that may be colored within like a coloring book. They may have outlines of virtually any image, such as scenery, animals, or other things. The outlines may simply be a pattern, such as paisley or polka dots. The pattern may a repeated pattern across the panel.

The windshield and side window sunshades may alternatively be made of a treated vinyl or such that is capable of accepting the type of ink that sign printers use. Such construction would also make possible the use of “static vinyl” that could be temporarily stuck to the window by static attraction, and removed when not in use or for re-drawing.

The side window versions may be shaped similarly to and able to to fit inside a car's side windows. Or is could be square, rectangular, oval, or round. It is envisioned that children could color their adjacent window's sunshade, then stick it to the inside of the window by any one of a variety of known fastening methods.

The invention may alternatively be embodied in or practiced using a home window version shaped to fit inside a home's windows. It could be square, rectangular, oval, or round. It is envisioned that children could color their bedroom window's sunshade, then stick it to the inside of the window by any one of a variety of known fastening methods.

It should be noted that, while many means of affixing shades to windows are referred to and well known, and while using some means to affix or position the present shades is important to the invention, no limitation to the particular means employed is intended or required by the invention. The references to mounting or positioning means provided herein are merely exemplary and not intended to limit the scope of the invention.

I claim:

1. A colorable sunshade system for an automobile comprising:
a thin panel having a periphery shaped to fit within one of an automobile's windows or windshield; the panel having an outer surface for disposition outwardly against an inside surface of glass of the window or windshield, and an inner surface visible to occupants of the automobile when the outer surface is so disposed; wherein
one of the inner surface or outer surface is comprised of a white background with an image printed thereon, the image comprising one or more dark outlines surrounding white interiors for being filled with color.

2. The colorable sunshade system of claim 1 further comprising means for temporarily affixing the outer surface into the disposition.

3. The colorable sunshade system of claim 2 further comprising one or more of crayons, markers, or paint for filling the white interiors with color.

4. The colorable sunshade system of claim 1 wherein the white background is comprised of paper.

5. The colorable sunshade system of claim 4 further comprising means for temporarily affixing the outer surface into the disposition.

6. The colorable sunshade system of claim 5 further comprising one or more of crayons, markers, or paint for filling the white interiors with color.

7. The colorable sunshade system of claim 6 wherein the means for temporarily affixing comprises a sticky layer on at least a portion of the outer surface.

8. The colorable sunshade system of claim 6 wherein the means for temporarily affixing comprises one of more hooks for hanging the panel from a top edge of the inside surface of glass.

9. The colorable sunshade system of claim 6 wherein the means for temporarily affixing comprises an extendible frame for securing the panel to a portion of the automobile surrounding the window or windshield.

10. The colorable sunshade system of claim 1 wherein the white background is laminated with a transparent glossy layer.

11. The colorable sunshade system of claim 10 further comprising means for temporarily affixing the outer surface into the disposition.

12. The colorable sunshade system of claim 11 further comprising ink markers.

13. The colorable sunshade system of claim 12 wherein the means for temporarily affixing comprises a sticky layer on at least a portion of the outer surface.

14. The colorable sunshade system of claim 13 wherein the means for temporarily affixing comprises one of more hooks for hanging the panel from a top edge of the inside surface of glass.

15. The colorable sunshade system of claim 12 wherein the means for temporarily affixing comprises an extendible frame for securing the panel to a portion of the automobile surrounding the window or windshield.

16. The colorable sunshade system of claim 1 wherein the white background is comprised of a dry-erasable surface.

17. The colorable sunshade system of claim 16 further comprising means for temporarily affixing the outer surface into the disposition.

18. The colorable sunshade system of claim 17 further comprising dry-erase markers.

19. The colorable sunshade system of claim 18 wherein the means for temporarily affixing is from the group including a sticky layer on at least a portion of the outer surface, one or more suction cups, and one of more hooks for hanging the panel from a top edge of the inside surface of glass.

20. The colorable sunshade system of claim 18 wherein the means for temporarily affixing comprises an extendible frame for securing the panel to a portion of the automobile surrounding the window or windshield.
